(19) United States
(12) Patent Application Publication
(10) Pub. No.: US 2010/0104003 A1
(43) Pub. Date: Apr. 29, 2010

(54) SYSTEM AND METHOD FOR SECURELY TRANSMITTING VIDEO DATA

(75) Inventors: William Dunn, Alpharetta, GA (US); Jerry Fraschilla, Snellville, GA (US); Rick DeLaet, Alpharetta, GA (US)

Correspondence Address: STANDLEY LAW GROUP LLP, 6300 Riverside Drive, Dublin, OH, 43017, US

(73) Assignee: MANUFACTURING RESOURCES INTERNATIONAL INC., Alpharetta, GA (US)

(21) Appl. No.: 12/258,042

(22) Filed: Oct. 24, 2008

(51) Int. Cl. H04N 7/12; H04N 7/173

(52) U.S. Cl. 375/240.01; 725/118; 375/E07.229

(57) ABSTRACT

Exemplary embodiments provide a system and method for securely transmitting video data to an electronic display. The video data may be transmitted using a wired or wireless application. Raw video data is encoded as a plurality of JPEG frames. A plurality of packets are created which may contain one frame or a portion of a frame of video. Each packet contains a unique header with information about the packet and a unique security key. After transmission each packet may be analyzed to determine if it was the intended transmission. The packets are re-assembled and displayed if they are the intended transmission. A default image or video is displayed if the received transmission is not the intended transmission. If a single packet is missing or is unintended, the previous packet may be repeated. Additional standard wireless encryption may also be used if utilizing a wireless application.

### CROSS-REFERENCE TO RELATED APPLICATIONS

This application is a non-provisional patent application and does not claim priority to any other applications.

### TECHNICAL FIELD

Exemplary embodiments relate generally to a system and method for securely transmitting video data to electronic displays.

### BACKGROUND AND SUMMARY OF EXEMPLARY EMBODIMENTS

Electronic displays have become useful for not only indoor entertainment purposes, but are now being utilized for indoor and outdoor advertising/informational purposes. For example, liquid crystal displays (LCDs), plasma displays, and many other flat panel displays are now being used to display information and advertising materials to consumers in locations outside of their own home or within airports, arenas, stadiums, restaurants/bars, gas station pumps, billboards, and even moving displays on the tops of automobiles or on the sides of trucks. In some cases, the electronic display is hard wired to the source of the video signal. In other instances, hard wiring the signal transmission for these devices would either be cost-prohibitive or impossible due to the nature of the mounting surface or surrounding environment and in some cases the fact that the display is attached to a moving vehicle. Thus, the video data for some of these displays must be transmitted wirelessly.

Furthermore, the popularity of high-definition television (HDTV) has created a demand for high-quality video and picture displays where previously a lower quality would suffice. A high-quality video signal typically contains a larger amount of data and thus poses additional problems based on the bandwidth available for transmission.

Another problem in transmitting this data is the risk of unintentional or intentional interference with the data transmission by a third party. For example, although the user has sent intended data to the displays, a third party may interject their own data and attempt to transmit alternative and possibly offensive material to the displays. These third parties may interject with wired setups by locating the source of the video, disconnecting it, and attaching their own source to send to the displays. In wireless applications, third parties may wirelessly send their own signals to receivers and override the intended signals. Therefore, there exists a need to securely transmit high-quality image data to electronic displays in both wired and wireless applications.

The exemplary embodiments herein disclosed are not intended to be exhaustive or to unnecessarily limit the scope of the embodiments. The exemplary embodiments were chosen and described in order to explain the principles so that others skilled in the art may practice the embodiments. Having shown and described exemplary embodiments, those skilled in the art will realize that many variations and modifications may be made to affect the described invention. Many of those variations and modifications will provide the same result and fall within the spirit of the exemplary embodiments. It is the intention, therefore, to limit the embodiments only as indicated by the scope of the claims.

### BRIEF DESCRIPTION OF THE DRAWINGS

A better understanding will be obtained from a reading of the following detailed description and the accompanying drawings wherein identical reference characters refer to identical parts and in which:

FIG. 1 is a flow chart showing the steps in an exemplary embodiment; and

FIG. 2 is a schematic showing the components of an exemplary embodiment.

### DETAILED DESCRIPTION OF PREFERRED EMBODIMENTS

Exemplary embodiments may display only a static image for a definite period of time. Further embodiments may cycle through several images, showing each image for a definite period of time. Also, embodiments may show full motion video. Exemplary embodiments may transmit high-definition video (HD) of at least 720i or 720p quality, preferably at 1080i or 1080p.

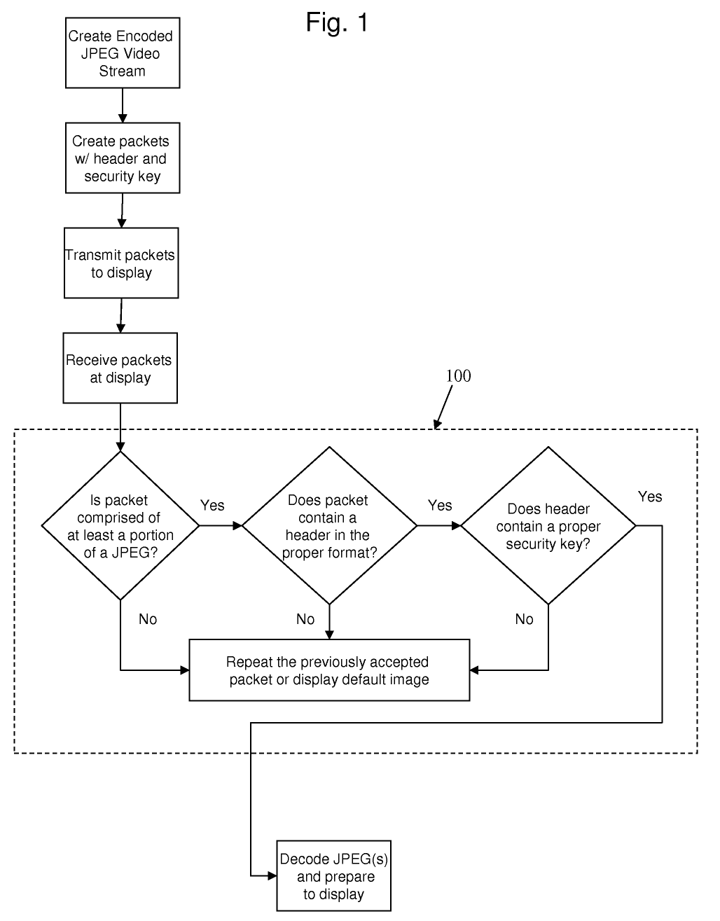

Referring now to FIG. 1, the source images or video may first be encoded as JPEGs. Obviously, for applications where only static images are to be shown, a single JPEG may be encoded for each image desired. Alternatively, if full motion video is desired, a plurality of JPEGs may be encoded to produce an encoded JPEG video stream. For compression purposes, only a small number of full captures (entire frames) may be encoded. These full captures are known as Intra-Frames (I Frames). Between the I Frames a full image may not be saved, but rather only the parts of the picture that have changed between it and the frame before. These ‘difference frames’ are known as Predicted Frames (P Frames). As well as P Frames, Bi-directional frames (B Frames) may also be kept. These B Frames are not actually frames but are better thought of as in-between data about the previous frame and the next frame after it. It should be pointed out that any reference to ‘frames’ in this application may symbolize I Frames, P Frames, or B Frames.

The particular method of compressing video may be similar to the popular MPEG format. There is of course a plurality of different compression techniques available for compressing the data for full motion video and any method may be practiced with exemplary embodiments. An exemplary embodiment may produce an encoded JPEG video stream by using one or more ADV212 single-chip JPEG 2000 codecs, which are commercially available from Analog Devices Inc., Norwood, Mass. www.analog.com.

By utilizing hardware with enough bandwidth to support very high data rates, embodiments may be practiced without compression.

Next, a plurality of packets for sending across the network may be created. The packets may contain a variety of different information. Most notably, a packet contains the information for the image or images to be displayed. A packet may contain an entire frame, or it may contain only a fraction of a frame. Each packet also contains a header which comprises instructions for re-assembling the packets into video frames once they have been transmitted. The header may contain instructions for the receiving CPU such as: which frame this packet applies to, how many frames are in this particular video stream, how many packets comprise this particular frame, etc. Each header, although containing different information, may have the same organization or format.

Each header may also contain information regarding on whose behalf the images are being presented (for example if advertising images are being displayed the header may identify the party on whose behalf the advertisement is being displayed). This allows a memory unit either at the transmitter or receiver to record how many advertisements have been shown for a particular party and possibly the total advertising time for an advertising period.

For security purposes, each header may also contain a unique security key which may or many not be dynamically generated for each packet. The security key can be generated according to one of multiple algorithms such as a CRC check sum or more complex algorithms that are altered based on random seeds. The security key may be tied to the particular frame number that the packet corresponds with. Thus the security key may be different for each frame and may be different for each packet.

Once the packets and their corresponding headers are generated, this data may be transmitted to a receiving apparatus at the electronic display. This transmission can be completed with a wired application or a wireless application. Wired transmission hardware is relatively well known in the art and thus will not be discussed further.

Regarding wireless applications, a variety of network communications may be used. Various formats of Transmission Control Protocol/Internet Protocol (TCP/IP) may be utilized. An exemplary embodiment may utilize User Datagram Protocol (UDP) as the network communication. Unlike TCP/IP configurations, this protocol stack does not require acknowledgement of each hardware packet, but rather leaves it up to each receiving apparatus to detect and handle lost network packets. Using UDP may be more efficient, especially when using multiple receiving apparatuses.

Once received, each packet is analyzed according to various parameters and either accepted or rejected. The analyzing step 100 is shown in FIG. 1 as only three logical commands, but embodiments may contain less or more of the commands shown in analyzing step 100. The various parameters include, but are not limited to, whether the packet itself comprises at least of a portion of a JPEG. If the packet does not comprise at least of a portion of a JPEG, then it is not the intended transmission and will be rejected. Another parameter which may be analyzed is the format of the header. As discussed above, the header may contain a number of different pieces of data, and this data may be unique to the specific header of the specific packet. However, the organization of the data within the header may be the same across different packets. For example, each header may contain, in this order: an indication of whether the images are static images or full motion video, the length of time the image will be displayed (if static), the length of the video, which frame this packet corresponds with, identification of the party on whose behalf the images will be displayed, and a security key. When the format of the header is analyzed, the system would determine whether the information in the header is of the proper type and is presented in the proper order. If not, then it is not the intended transmission and will be rejected.

Also, the security key within the header may be analyzed. Security keys may also have a proper format and the format of the security key may be analyzed. Of course, only a select number of security keys may be authorized and these keys may change dynamically. Thus, the content of the security key itself may be analyzed and compared to the security keys which are authorized for display. In exemplary embodiments, a separate transmission packet may be sent to the receiving apparatus which identifies security key inputs such as seed values and algorithm types so that the receiving apparatus knows how to verify the security keys and even the packets themselves.

After the desired parameters are analyzed, if any of the parameters fail then the packet is not the intended transmission and will be rejected. When a packet is rejected, an embodiment may repeat the previously accepted packet and continue to analyze the next packet in the order. If the next packet is also rejected, an embodiment may again repeat the previously accepted packet, or may display a default image or video which is stored at the display. Depending on the frame speed and the images or video being shown, several packets may be repeated before this would be noticeable by an observer of the electronic display. Once noticeable, an embodiment may display a default image or video. However, if the parameters are acceptable then the packet is an intended transmission and will then be decoded.

In some embodiments, the images may be substantially instantaneously streamed to the electronic display and shown on the visible screen. With wired applications, most images and video can easily be instantaneously streamed to the display. However, for wireless applications, streaming might only be applicable for static images and standard definition video. However, if full motion high-definition video is to be displayed, this data may require storing in a video buffer for display at a specified time. The video buffer may be required if the size of the full motion video data is too large to stream instantaneously to the display. In this case, the video data is stored at the buffer and the buffer may be later instructed to display the data at a specified time. Whether a video buffer is utilized will depend on a number of factors including the amount of data to be transferred (which may depend upon the quality of video/images to be shown) and the speed at which the wireless network can transfer the data.

In addition to the techniques described herein, the use of standard wireless security communication protocols may be used with exemplary embodiments for additional security when a wireless application is desired. Standard encryption methods include, but are not limited to: Wired Equivalent Privacy (WEP), Wi-Fi Protected Access (WPA), Temporal Key Integrity Protocol (TKIP), Extensible Authentication Protocol (EAP), Lightweight Extensible Authentication Protocol (LEAP), Protected Extensible Authentication Protocol (PEAP), 802.11i, WPA2, RADIUS servers, and pre-shared keys (PSK). RF shielding techniques may also be used to ensure that transmitted signals do not leak out of the structures in which they are being sent, giving hackers an opportunity to discover the source signals and hack them.

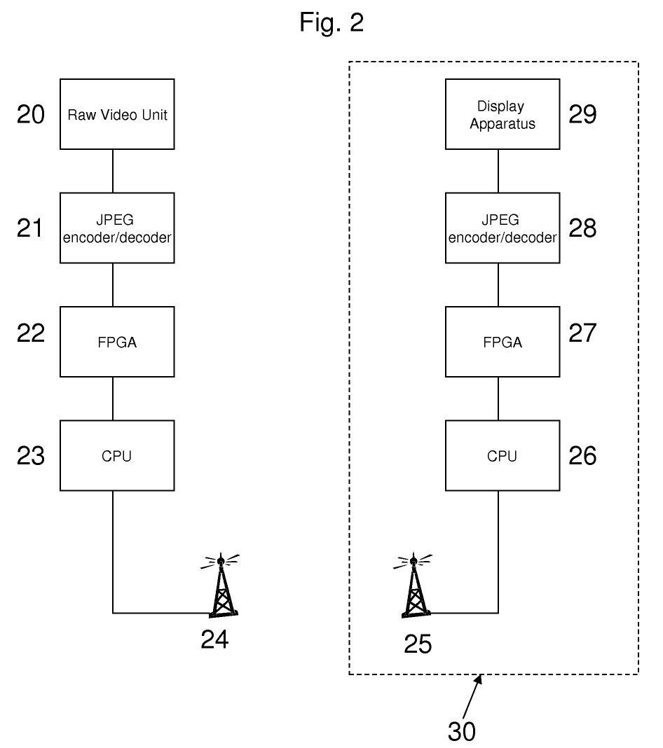

FIG. 2 shows how the structure of an exemplary embodiment may be connected. The raw video unit 20 sends the raw video to the JPEG encoder/decoder 21 to produce an encoded JPEG video stream. This data may then be sent to the field-programmable gate array (FPGA) 22 and on to the central processing unit (CPU) 23 where each JPEG frame may be broken into one or more packets, provided with a header and a corresponding security key. The packets are then sent to the transmitter 24, which transmits the packets. A receiver 25 is adapted to receive the packets. Again it is worth noting, that although the transmitter 24 and receiver 25 are shown in FIG. 2 as a wireless application, embodiments may be practiced for both wired and wireless applications.

The receiver 25 sends the packets to another CPU 26 for analysis and re-building the packets into their proper frames. The CPU 26 then sends the resulting data to another FPGA 27 and then to a second JPEG encoder/decoder 28 to decode the JPEGs back into raw video. The raw video is sent to the display apparatus 29 which comprises an electronic display of any of the following types: liquid crystal display (LCD), plasma display, organic light emitting diode display (OLED), or digital light processing display (DLP). The display apparatus 29 may comprise other components as well, including but not limited to a video buffer.

The components 26-29 are known collectively as a receiving display assembly 30. It should be noted that embodiments may use a plurality of receiving/display assemblies 30 in connection with one transmitter 25.

Having shown and described preferred embodiments, those skilled in the art will realize that many variations and modifications may be made to affect the described embodiments and still be within the scope of the claims. Thus, many of the elements indicated above may be altered or replaced by different elements which will provide the same result and fall within the spirit of the claimed embodiments. It is the intention, therefore, to limit the invention only as indicated by the scope of the claims.

What is claimed is:

1. A method for securely transmitting and displaying video data comprising the steps of:
providing raw video data;
encoding said raw video data into JPEG video stream;
creating a plurality of packets which comprise at least at least a portion of each JPEG frame;
associating a unique header with each of said packets;
transmitting said packets and associated headers to a receiving device;
analyzing various parameters of the packet and header;
decoding said JPEG packets into raw video data if the packet parameters are acceptable; and
displaying said raw video data.

2. The method of claim 1 wherein said parameter to be analyzed is the format of the header.

3. The method of claim 1 wherein said parameter to be analyzed is the format of the packet.

4. The method of claim 1 further comprising the steps of:
presenting a plurality of acceptable security keys;
associating a security key with each of said headers; and
wherein said analyzing various parameters step comprises comparing the security key of each header with the acceptable security keys.

5. The method of claim 1 further comprising the step of:
storing the raw video in a video buffer prior to displaying.

6. The method of claim 1 wherein:
said transmitting step is performed wirelessly and said transmitter is adapted to encrypt the packets and their associated heads with standard wireless encryption prior to transmitting.

7. The method of claim 1 wherein:
said displaying step is performed at least by a liquid crystal display.

8. The method of claim 1 further comprising the step of:
repeating a previously acceptable packet if the parameters of the current packet are not acceptable.

9. A system for securely transmitting video data to electronic displays comprising:
an encoding device adapted to encode raw video data;
a first central processing unit in communication with said encoding device and adapted to divide the encoded data into a plurality of packets and associate a unique header with each packet;
a transmitting device in communication with said first central processing unit and adapted to transmit said packets and headers;
a receiving device adapted to receive said packets and headers;
a second central processing unit in communication with said receiving device and adapted to analyze said headers and assemble said packets into encoded video data;
a decoding device in communication with said second central processing unit and adapted to decode the video data; and
an electronic display in communication with said decoding device and adapted to display the video data.

10. The system of claim 9 further comprising:
a video buffer in communication with said decoding device and said electronic display.

11. The system of claim 9 further comprising:
a first field-programmable gate array in communication with said encoding device and said first central processing unit; and
a second field-programmable gate array in communication with said second central processing unit and said decoding device.

12. The system of claim 9 wherein:
said encoding device and said decoding device are JPEG encoder/decoder chips.

13. The system of claim 9 wherein:
said electronic display is a liquid crystal display.

14. The system of claim 9 wherein:
said transmitting device is a wireless transmitting device and further comprises a wireless encryption device in communication with said transmitting device.

15. The system of claim 9 further comprising:
a plurality of receiving devices adapted to receive said packets and headers;
a plurality of central processing units in communication with said receiving devices and adapted to analyze said headers and assemble said packets into encoded video data;
a plurality of decoding devices in communication with said second central processing units and adapted to decode the video data; and
a plurality of electronic displays in communication with said decoding device and adapted to display the image data.

16. The system of claim 9 wherein said video data is at least of the quality of 720i.

17. A system for securely transmitting and displaying video comprising:
an encoding and transmitting assembly comprising:
an encoding device adapted to encode raw video data;
a first field-programmable gate array in communication with said encoding device;
a first central processing unit in communication with said first field-programmable gate array and adapted to divide the encoded data into a plurality of packets and associate a unique header with each packet;
a transmitting device in communication with said first central processing unit and adapted to transmit said packets and headers;
a plurality of receiving display assemblies in communication with said encoding and transmitting assembly, each receiving display assembly comprising:
a receiving device adapted to receive said packets and headers;
a second central processing unit in communication with said receiving device and adapted to analyze various parameters of said headers and said packets and assemble said packets into encoded video data;
a second field-programmable gate array in communication with said second central processing unit;
a decoding device in communication with said second field-programmable gate array and adapted to decode the video data; and
an electronic display in communication with said decoding device and adapted to display the video data.

18. The system of claim 17 wherein:
said encoding device and said decoding device are JPEG encoder/decoder chips.

19. The system of claim 17 wherein said video data is at least of the quality of 720i.

20. The system of claim 17 wherein:
said transmitting device is a wireless transmitting device and further comprises a wireless encryption device in communication with said transmitting device.
